(19) United States
(12) Patent Application Publication
(10) Pub. No.: US 2009/0087247 A1
(43) Pub. Date: Apr. 2, 2009

(54) Low voltage battery operated handheld waxing depilatory device

(76) Inventors: Charles E Jennings, Concord, CA (US); Donald F. Jewell, Walnut Creek, CA (US)

Correspondence Address: CHARLES E. JENNINGS, 712 BANCROFT ROAD SUITE 805, WALNUT CREEK, CA, 94598, US

(21) Appl. No.: 12/286,367

(22) Filed: Sep. 29, 2008

Related U.S. Application Data
(60) Provisional application No. 60/995,908, filed on Sep. 27, 2007.

(51) Int. Cl. A46B 11/08; H05B 1/00

(52) U.S. Cl. 401/1; 219/201; 219/221; 219/227

(57) ABSTRACT

This invention relates to a low voltage battery operated handheld waxing depilatory device used to remove unwanted body hair quickly, safely and with ease by allowing a depilatory wax stick to enter an opening in the battery door (100) through which the wax stick is conveyed by the battery/wax stick support (80) by the Advance Assembly lever (40) which guides it towards and through the Heating Element Guide (30) to the Heating Element (20) where the wax reaches it melting point then is gentle forced by the Advance Assembly lever (40) causing the melted wax to pass through the Heating Element's opening (20) to the reach the surface where it is being applied.

### CROSS REFERENCES TO RELATED APPLICATION

This application claims the benefit of Provisional Patent Application Ser. No. 60/995,908 Filed 2007 Sep. 27.

### BACKGROUND

1. Field of Invention

This invention relates to low voltage battery operated handheld waxing depilatory device that is used in the removal of unwanted body hair quickly, safely and with ease.

2. Description of Prior Art

The art of removing unwanted body hairs using heated or unheated waxes is a service that is often offered by spas, hair and nail salons, specialty shops and other similar business establishments. The present invention is directed to a low voltage battery operated handheld apparatus for removing hair by the application of a wax having a low melting point and in particular to an applicator system which stores and safely applies the low melting point depilatory wax to the skin in sufficient and exact concentrations to maximize the effectiveness of epilation in a painless manner.

Epilation by the application of heated and unheated depilatory wax to the skin and removal of the wax from the skin after cooling is an accepted technique for effective, long-lasting hair removal. As the heated or unheated wax is applied to the skin, a cloth or cloth strips is also pressed into the wax on the skin. After the wax cools and hardens, the cloth or cloth strips is pulled back. The wax and hair mixture is intertwined onto the cloth or cloth strips which completes the cycle of hair removal from a human's pores.

The accepted commercial technique of removing hair by application of a hot wax depilatory usually includes heating a large quantity of depilatory wax to a molten state in a large, open vat. The individual then tests the temperature of the wax by touching the mixture in the vat. Generally, a skilled individual will apply the melted wax by dipping a spoon or stick applicator into the vat and collecting a blob of molten wax on the applicator and coating the skin in the area where hair is to be removed. Wax is wasted due to the dripping and spilling as the applicator is removed from the vat. Moreover, when the wax is heated to a molten state for application to the skin, it retains a high viscosity similar to that of molasses or thick honey due to the properties thereof. Because of the high viscosity property, the depilatory wax tends to be applied to the skin in thick blobs.

The application of depilatory wax for removal of body hair is an old and well-known technology. Numerous forms of wax applicators have been disclosed in the art. By way of an example, U.S. Pat. No. 4,958,951 to Mann discloses a roller based applicator having a reservoir for heating the wax prior to dispensing it onto the skin. In U.S. Pat. No. 5,279,080 to Muller and Hauck discloses a hair removal device using an abrasive wheel. U.S. Pat. No. 5,980,536 to Jamali discloses a hair removal applicator and container that requires heating before applying to the skin surface. In U.S. Pat. No. 6,478,493 to Cepeda discloses a wax-stick hair removal device that uses heat and cloth strips. U.S. Pat. No. Des 285,155 to Mathews discloses a sheet of hair removing strips. In U.S. Pat. No. 6,709,180 to Conchran discloses an ergonomic wax pen for various industrial applications that still require the unit to be heated and some type of removal system to lift the hair follicles from the skin.

Thus, there appears to be a continuing need for a depilatory wax applicator which is of a simple and low cost configuration, but will enable a low skilled user to apply a fine deposit of the wax in a small, localized area where delicate touch and control is more important than quantity and speed of application.

### OBJECTS AND ADVANTAGES

The present invention meets the aforementioned continuing need by providing a low temperature wax and applicators system that consist of a low voltage battery operated handheld waxing depilatory device which is simple, low cost and easy to use on the facial and neck surfaces and even in delicate areas such as toes and bikini lines where very fine wax deposition is required. In a preferred embodiment disclosed herein, the low voltage battery operated handheld waxing depilatory device has the following advantages over prior art:

a) Portable—easily transportable and storable for personal and professional use;
b) Extremely accurate and easy to use;
c) Uses a specially formulated depilatory wax with a low melting point
d) Ergonomically designed for easy of use and reducing fatigue
e) Economical to use—less than one percent loss of wax
f) Minimizing loss of the wax's effectiveness due to reheating
g) Minimize contamination between users in a professional environment
h) Built in system prevents leakage from molten wax back into the housing
i) Low energy consumption—no messy hot vats of wax

Further objects and advantages are to provide a low skill tool for applying a depilatory wax and reduce the danger of injury to clients or individuals using a depilatory wax to remove excessive hair follicles from the body. Still further objects and advantages will become apparent from a consideration of the ensuing description and drawings.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1. is a three dimensional view of the low voltage battery operated handheld waxing depilatory device

FIG. 2 is a top view of the low voltage battery operated handheld waxing depilatory device of FIG. 1

FIG. 3 is a side view of the low voltage battery operated handheld waxing depilatory device of FIG. 1

FIG. 4 is a exploded view of the low voltage battery operated handheld waxing depilatory device

FIG. 5 is a cut away side view of the low voltage battery operated handheld waxing depilatory device.

### REFERENCE NUMERALS IN DRAWINGS

| | |
|---|---|
| 10 | Tip |
| 20 | Heating element |
| 30 | Heating element Guide |
| 40 | Advance Assembly Lever |
| 50 | Switch Assembly |
| 60 | Waxing Applicator Device |
| 70 | Battery Contacts |
| 80 | Battery/Wax Stick Support |
| 90 | Battery Door Latch |
| 100 | Battery Door |
| 110 | Left side Plastic Housing |
| 120 | Right side Plastic Housing |

### SUMMARY

Accordingly, it is a general object of the present invention to provide an improved low voltage battery operated handheld waxing depilatory device that is effective in removing unwanted follicles quickly, safely and with ease at a low cost to the user. It is a more particular object of the present invention to provide an improved, efficient, and portable system of depilation using a low temperature wax that is safe to use in a personal or professional environment.

By taking a cylindrical wax stick and placing it inside low voltage battery operated handheld waxing depilatory device and activating switch assembly the process begins. The electrical energy from the batteries is conveyed to the battery contact which then transfers electrical energy to the switch assembly which then convey the electrical energy to the heating element which converts the electrical energy into thermal energy that create sufficient heat to liquefy the low temperature wax which allows the Advanced Assembly lever to use mechanical energy to inject the wax stick through the heating element guide into the heating element cavity. Once the wax is fluid and the mechanical energy of the Advanced Assembly lever is applied to the wax stick, the liquefied wax is expelled from the tip of the heating element on to the application area.

### DESCRIPTION OF THE PREFERRED EMBODIMENTS

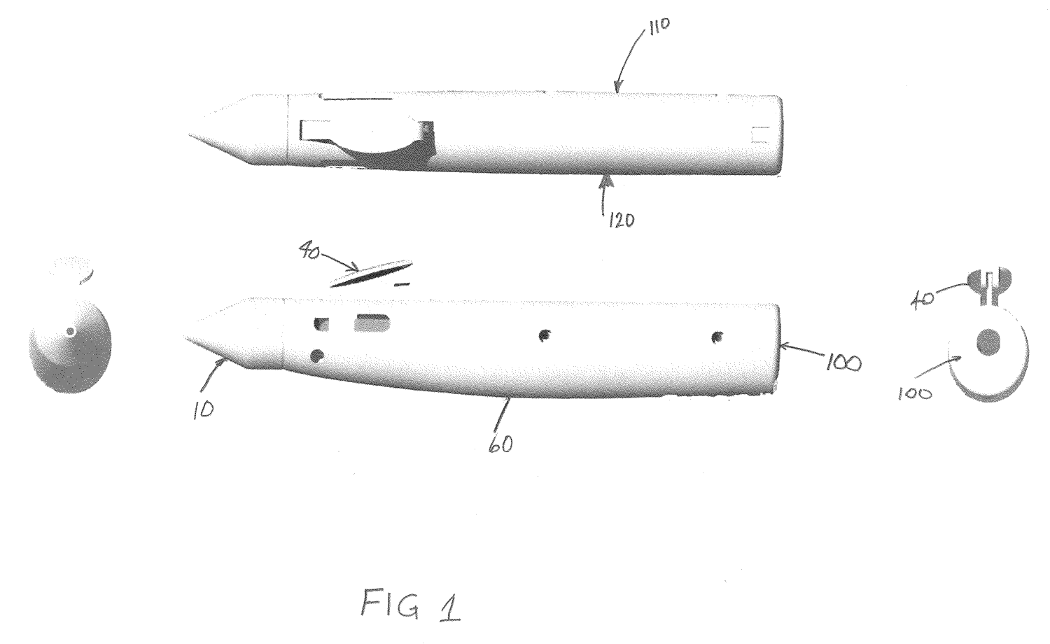

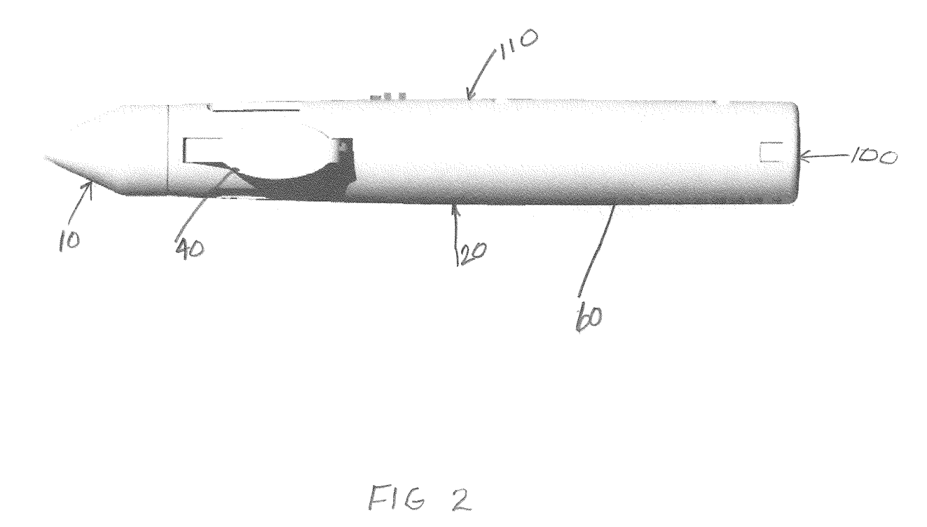

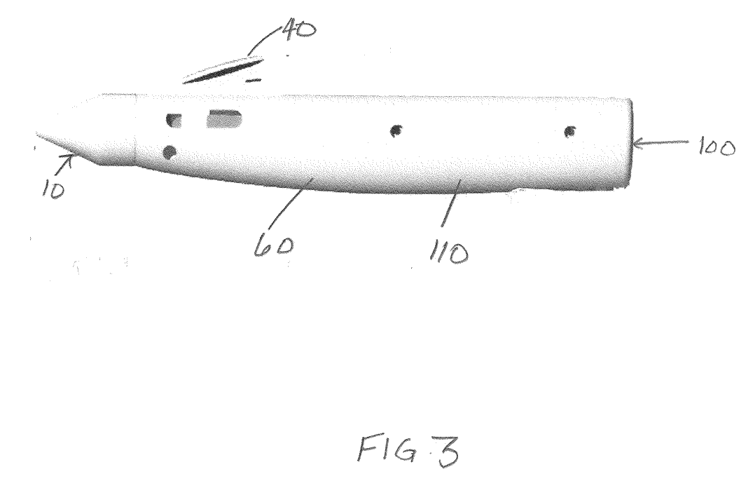

FIG. 1, FIG. 2 and FIG. 3 sets forth a three dimensional view of the low voltage battery operated handheld waxing depilatory device (60). The plastic housing (110,120) is an egomaniacally design structure that has a tip (10) to prevent accidental leakage of waxing depilatory device (60) during non usage. The Advance Assembly Lever (40) as seen protruding from the plastic housing (110,120) is used to advance the wax stick through the waxing depilatory device (60).

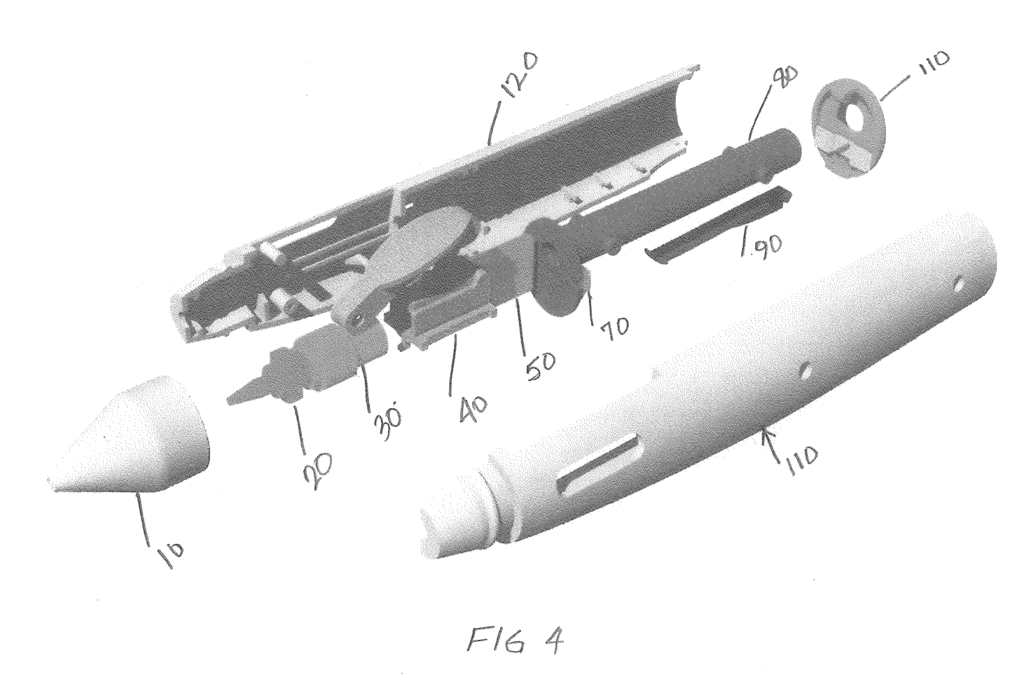

FIG. 4 is an exploded view of the low voltage battery operated handheld waxing depilatory device (60) showing how the various components are assembled and interconnected. The heating element (20) is connected the heating element guide (30) which has the Advanced Assembly Lever (40) held in place by a prefabricated dole on the plastic housing (110, 120) that allows the Advance Assembly Lever (40) to engage the wax stick that is being guided by the battery/wax stick support (80). The system is electrically charged when the batteries are installed into the battery/wax stick support (80), and the battery door (100) which is supported by the battery door latch (90) is closed. We then activate the switch assembly (50) and the electrical energy will pass through the battery contacts (70), switch assembly (50) and energize the heating element (20) which provides sufficient thermal energy to liquefy the wax and the Advanced Assembly lever (40) forces the liquefied wax out of the heating element's (20) discharge opening.

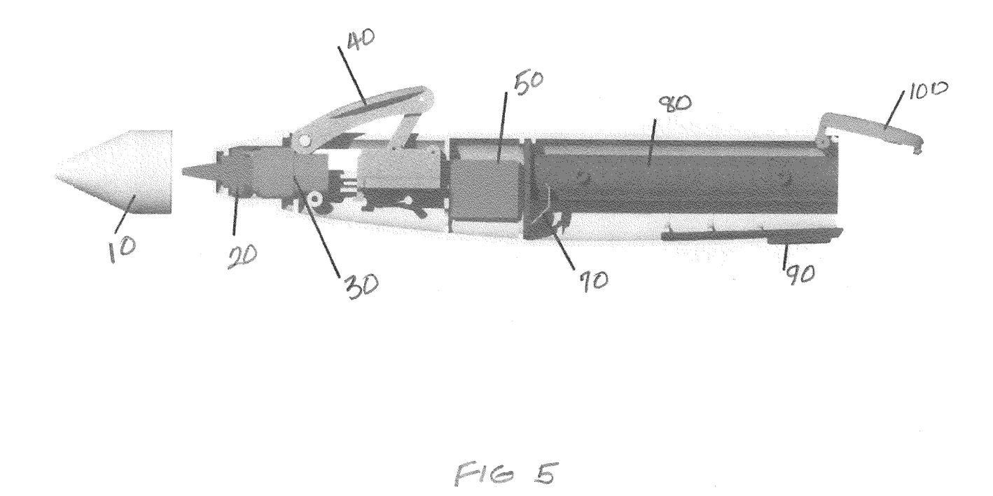

FIG. 5 is a cut-away side view of the low voltage battery operated handheld waxing depilatory device. As demonstrated in FIG. 4, the wax enters the hole in the battery door (90). The battery/wax stick support (80) guides the wax stick through the waxing depilatory device (60) by using the Advance Assembly lever (40) and heating element guide (30). When the power source, batteries, have been installed into the battery/wax stick support (80), and the batteries come into contact with the battery contacts, the system becomes electrically energized. By activating the switch assembly (50) the flow of electrical energy leaves the battery through the battery contact pass through switch assembly (50) towards the heating element (20) where the heating element convert the electrical energy into thermal energy to liquefy a low temperature wax stick. Once the wax is in a liquid state the Advance Assembly lever (40) discharges the liquefy wax through the heating element (20) on to the desired surface.

### Operation

The application and operation of a low voltage battery operated handheld waxing depilatory device is similar to most system using a depilatory wax and applicator. The wax stick enters the opening in the battery door (100). The wax stick is supported while it is traveling to the heating element (20) by the battery/wax stick support structure (80) and the heating element guide (30). The Advance Assembly mechanism (40) is used to advance the wax stick to the heating element guide assembly (30). Once the wax stick is in place, the button on the Switch Assembly (50) is turned to the “On” position. The Switch Assembly (50) in the “On” position allowing electrical energy to flow from the batteries through the battery contacts (70) into the circuit in the Switch Assembly (50) to a wire connected to the heating element (20) where it is converted into thermal energy.

Once the wax stick reaches its melting point as indicated by the “Ready” light on the Switching Assembly (50), the Advance Assembly lever (40) using mechanical energy will direct the liquefied wax through the heating element's guide (30) into the heating element's cavity onto the surface through the opening in the heating element (20).

### CONCLUSION, RAMIFICATION AND SCOPE

Based on the reader understanding of the art, it is very obvious that the low voltage battery operated handheld waxing depilatory device provides a system that does not require a highly skilled user and it safe to the client.

The present invention offers a low temperature wax and applicators system that consist of a low voltage battery operated handheld waxing depilatory device which is simple, low cost and easy to use on the facial and neck surfaces and even in delicate areas such as toes and bikini lines where very fine wax deposition is required. The low voltage battery operated handheld waxing depilatory device has the following advantages:

a) Portable, easily transportable and storable for personal and professional use;
b) Extremely accurate and easy to use;
c) Uses a specially formulated depilatory wax with a low melting point—no strips required
d) Ergonomically designed for easy of use and reducing fatigue
e) Economical to use-less than one percent loss of wax
f) Minimizing loss of the wax's effectiveness due to reheating
g) Minimize contamination between users in a professional environment
h) Built in system prevents leakage from molten wax back into the housing
i) Low energy consumption—no messy hot vats of wax

Although the description above contains many specificities, these should not be construed as limiting the scope of the invention but as merely providing illustrations of some of the presently preferred embodiments of this invention. For example the heating element mechanism can be designed to have a wider opening allowing for a greater coverage. The modification of the battery housing can incorporate a design to allow the invention to be recharged from a stationary source.

There are several advantages of this invention: 1) providing a low skill tool for applying a depilatory wax and 2) reducing the danger of injury to clients or individuals using a depilatory wax to remove excessive hair follicles from their bodies. Thus the scope of the invention should be determined by the appended claims and their legal equivalents, rather than by the examples given.

I claim:

1. In a depilatory waxing applicator device comprising a light weight plastic body having a microelectronic switching mechanism that controls the electrical energy to a heating element device which can liquidify a low temperature wax stick that is guided along a battery/stick support structure by an advancing assembly mechanism through a heating element guide structure towards the heating element which heats the wax which then flows onto the application point.

2. The wax applicator device of claim 1 wherein said body and non metal components are composed of a heat resistant plastic or heat resistant plastic material with a metallic film coating

3. The wax applicator device of claim 1 wherein said microelectronic switching mechanism controls the temperature range of the heating element mechanism to less than 170° F. during its operation

4. The wax applicator device of claim 1 wherein said microelectronic switching mechanism contains several LED light which indicate, “On”, “Low Battery”, “Ready”.

5. The wax applicator device of claim 1 wherein said heating element is composed of material that when electrical energy passes through it, the resistance creates a thermal energy sufficient to heat the wax stick to a point where it is fluid

6. The wax applicator device of claim 1 wherein said battery and battery support can be replaced with a single light weight solid rechargeable battery mechanism

7. The wax applicator device of claim 1 wherein said advance assembly mechanism can be replaced with a screw type electrically power advance assembly mechanism.
